(19) United States
(12) Patent Application Publication
(10) Pub. No.: US 2013/0019422 A1
(43) Pub. Date: Jan. 24, 2013

(54) Sunroof Genie Turbo; a vehicle sunroof drain tube snake.

(71) Applicants: Sandra Nilene Miller, Yelm, WA (US); Paul Arnold Miller, Yelm, WA (US); Jamacca Valene Larman, Rainier, WA (US); Cole Ryan Larman, Rainier, WA (US); Chase Anthony Valentine, Yelm, WA (US)

(72) Inventors: Sandra Nilene Miller, Yelm, WA (US); Paul Arnold Miller, Yelm, WA (US); Jamacca Valene Larman, Rainier, WA (US); Cole Ryan Larman, Rainier, WA (US); Chase Anthony Valentine, Yelm, WA (US)

(21) Appl. No.: 13/535,776

(22) Filed: Jul. 30, 2012

Related U.S. Application Data
(60) Provisional application No. 61/572,499, filed on Jul. 18, 2011.

(51) Int. Cl. B08B 9/04

(52) U.S. Cl. 15/104.095

(57) ABSTRACT

The sunroof genie turbo; a vehicle sunroof drain tube snake, generally contains a housing; a unspecified length of snake, that rotates outwardly with respect to the housing; a coupling member for securing the snake to a rotating shaft which can be controlled by a switch. The housing encloses the internal components that operate the snake, including, but not limited to, a motor, a power source, and a switch. The sunroof genie turbo; a vehicle sunroof drain tube snake, which can be built in a great variety of shapes and sizes, is designed to penetrate and dislodge dirt and debris that clog or obstruct a vehicles sunroof drain tubes.

### CROSS-REFERENCE TO RELATED APPLICATIONS

The present application claims priority to U.S. Provisional Application Ser. No 61/572,499 filed Jul. 18, 2011, the entire disclosure of which is incorporated herein by reference.

### BACKGROUND OF THE INVENTION

The present invention relates to a specialty hand held tool designed primarily for adults. Various such products are marketed through catalogs, magazines, retail businesses, and web sites. It is a paramount object of the present invention to provide the end user a operable do-it-yourself hand held drain tube snake designed to dislodge dirt and debris obstructing a vehicles sunroof drain tubes. This invention fills a great need, has great consumer appeal, and is easy to operate and maintain.

### SUMMARY OF INVENTION

The present invention is the sunroof genie turbo; a vehicle sunroof drain tube snake, intended to penetrate, rotate, and dislodge dirt and debris that clog or obstruct a sunroofs drain tubes. The present invention contains a hollow housing; a unspecified length of snake; a coupling member for securing the snake; and a rotating shaft which can be controlled by a switch. The housing encloses the internal components that operate the snake, including but not limited to a motor and power source.

### DESCRIPTION OF THE DRAWINGS

FIG. 1, is a perspective view of the exemplary model of the sunroof genie turbo: a vehicle sunroof drain tube snake made in accordance with the present invention;

FIG. 2, is a exploded perspective view of the exemplary model of the sunroof genie turbo: a vehicle sunroof drain tube snake made in accordance with the present invention FIG. 1, the housing 2.4 and 2.10 when secured together with object 2.3 enclose the internal components that operate the snake 2.12.

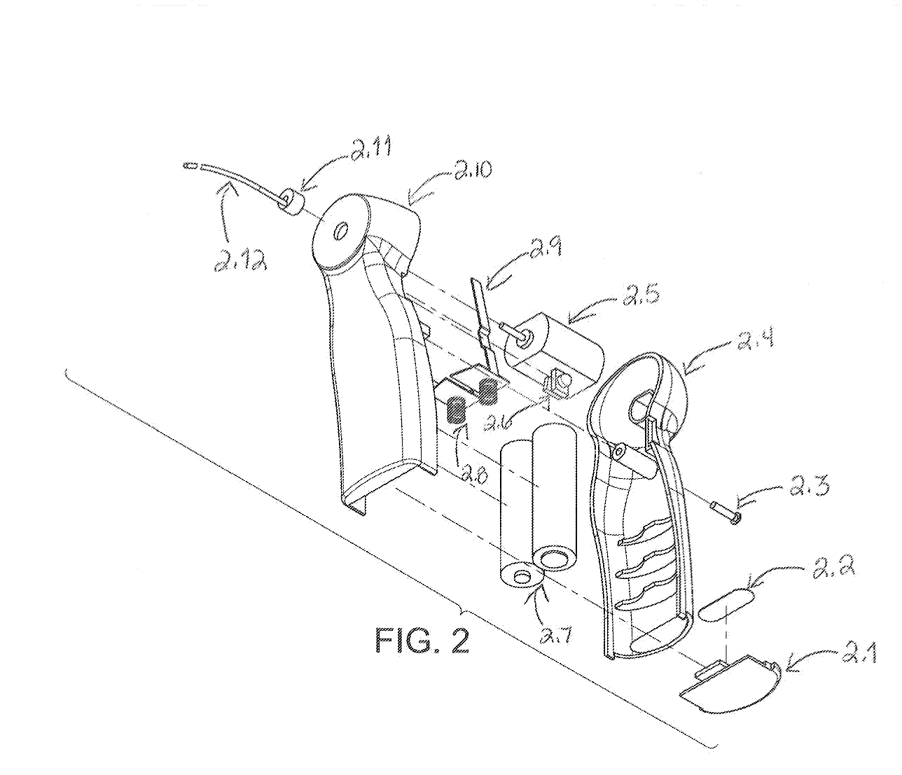

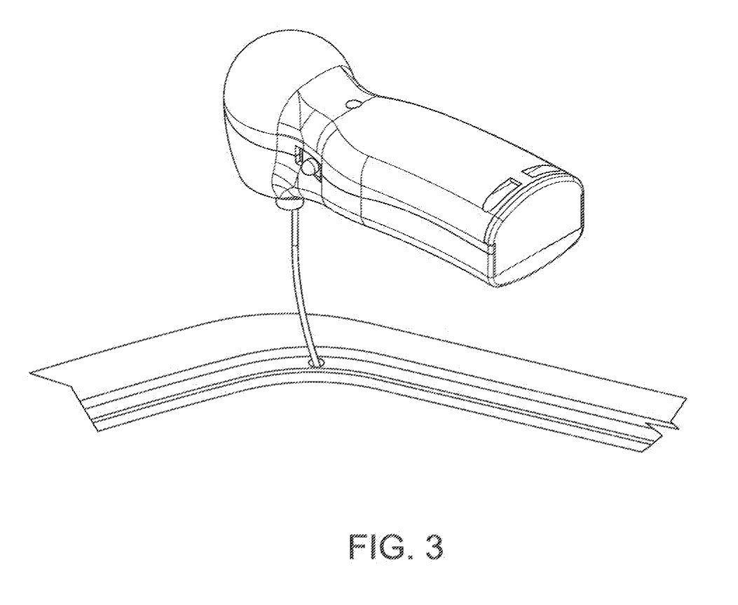

Specifically, as illustrated in FIG. 2, there is an internal cavity in the upper portion of the housing 2.10 that receives and retains a motor 2.5. The motor 2.5 is powered by batteries 2.7, a conductor panel 2.2, or any other power source that is received and retained in the cavity compartment as shown in housing 2.4 and secured by a hatch, or cover 2.1.

Also illustrated in FIG. 2, a simple circuit can be created by a simple thumb switch 2.6 being moved or pushed, thus causing the lead 2.9, attached to springs, or terminals 2.8, having a positive and a negative wire (not shown) soldered from the terminal base to the motor 2.5, which activates the batteries or any other power source 2.7 when touching the conductor panel 2.2, consequently allowing the motor to rotate respectively. When energized, the motor 2.5 turns a shaft, which extends through the housing 2.10, that has an external coupling attached 2.11 which secures snake 2.12 to shaft thus allowing snake to continuously rotate.

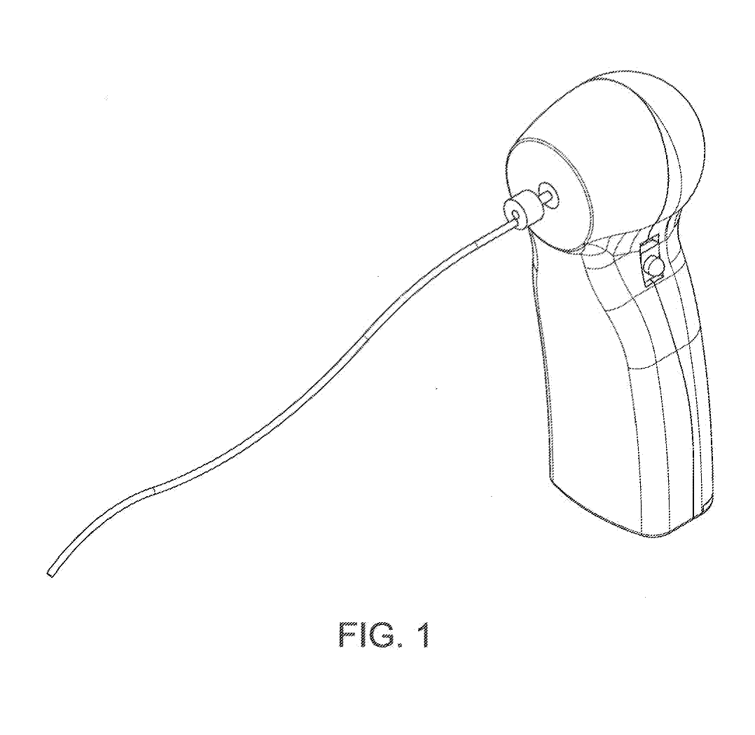

FIG. 3, is a perspective view of the exemplary model of the sunroof genie turbo; a vehicle sunroof drain tube snake FIG. 1, inserted in vehicles sunroof drain tube as it is intended to be use.

The above description is illustrative and not restrictive. The true scope and spirit of the invention resides in the appended claims and their legal equivalents. Modifications and variations on the embodiments described herein, or known to those skilled in the art, could be made, but would not take away from the initial intended purpose of the invention as defined by the appended claims.

What is claimed is:

1. The sunroof genie turbo; a vehicle sunroof drain tube snake, containing; a hollow housing having two distal ends, the first distal end and the second distal end, said housing is adapted to be grasped and held by a user between the first distal end and the second distal end; a unspecified length of snake positioned near the first distal end of the housing containing a rotating shaft which is adapted to rotate with driving force outwardly with respect to the housing, and a coupling member, for securing said snake to shaft, said snake is being powered by a motor and power source enclosed within the housing cavity and a switch positioned on the exterior surface of the housing between first distal end and second distal end, allowing the user to selectively energize the motor which rotates said snake for penetrating and clearing the sunroof drain tube from dirt and debris, while grasping the housing between both distal ends. The second distal end consists of a hatch or cover which opens to insert a power source and closes to secure said power source within said housing.

2. The sunroof genie turbo; a vehicle sunroof drain tube snake as recited in claim 1, wherein said snake is a unspecified length of flexible line, with a penetrating end.

3. The sunroof genie turbo; a vehicle sunroof drain tube snake as recited in claim 2, wherein the snake is secured to the rotating shaft by a circular coupling member.

4. The sunroof genie turbo; a vehicle sunroof drain tube snake as recited in claim 3, wherein the snake is rotated by driving force outwardly away from the upper hollow housing.

5. The sunroof genie turbo; a vehicle sunroof drain tube snake as recited in claim 4, wherein the snake is inserted into one of the sunroof drain tubes will dislodge dirt and debris build up.
